(19) United States
(12) Patent Application Publication
(10) Pub. No.: US 2025/0382196 A1
(43) Pub. Date: Dec. 18, 2025

(54) GAHNITE PARTICLES AND METHOD FOR PRODUCING SAME, RESIN COMPOSITION AND MOLDED PRODUCT

(71) Applicant: DIC Corporation, Tokyo (JP)

(72) Inventor: Ryuichi KIYOOKA, Chiba (JP)

(73) Assignee: DIC Corporation, Tokyo (JP)

(21) Appl. No.: 18/877,247

(22) PCT Filed: Jul. 20, 2023
(86) PCT No.: PCT/JP2023/026499

§ 371 Date: Dec. 19, 2024

(30) Foreign Application Priority Data
Jul. 28, 2022 (JP) 2022-120425

(51) Int. Cl. C01G 39/02; C08K 3/22

(52) U.S. Cl. CPC C01G 39/02; C08K 3/22; C01P 2004/61; C01P 2004/62; C01P 2006/40; C08K 2003/2227; C08K 2003/2255; C08K 2003/2296; C08K 2201/001

(57) ABSTRACT

An object is to provide an metal complex oxide having excellent thermal conductivity and dielectric properties, a resin composition containing the metal complex oxide and capable of expressing excellent thermal conductivity and dielectric properties, and a molded product thereof. Specifically, a gahnite particle that includes zinc atoms, aluminum atoms, and oxygen atoms, and molybdenum atoms and has a dielectric loss tangent of 1.0×10⁻³ or less at 1 GHz is used.

### TECHNICAL FIELD

The present invention relates to a gahnite particle and a method for producing the same.

### BACKGROUND ART

There has been a demand for smaller, lighter, and higher performance devices, and this demand has led to higher integration and larger capacity of semiconductor devices. As a result, the amount of heat generated in the components of the devices is increasing, and there is a growing need to improve the heat dissipation function of the devices.

One of known methods for improving the heat dissipation function of devices is, for example, to impart thermal conductivity to an insulating member, more specifically, to add an inorganic filler to a resin that serves as the insulating member. The inorganic filler used in this method includes, for example, alumina (aluminum oxide), boron nitride, aluminum nitride, magnesium oxide, and magnesium carbonate.

On the other hand, as the volume of information communication has increased in recent years, information communication in high frequency bands has become more active. In order to reduce transmission loss in the components of the devices, there is a growing need for inorganic fillers with excellent dielectric properties (low dielectric constant and low dielectric loss tangent).

PTL 1 discloses spinel particles having an average particle size D50 of 0.01 μm to 5 μm and D90/D10 of 5 or less and in which the proportion of particles of 15 μm or more is 0.1% by volume or less of the total volume of all particles, wherein the spinel particles have both high thermal conductivity and low dielectric loss tangent. However, the spinel particles in this literature are particles represented by a chemical composition MgAl₂O₄, and the literature has no mention as to gahnite particles.

PTL 2 discloses, as an inorganic filler, a spinel compound oxide particle including metallic atoms, aluminum atoms, and oxygen atoms, and molybdenum atoms, in which a crystallite size in a plane is 100 nm or more. Zinc atoms, cobalt atoms, or strontium atoms are described as the metallic atoms, and, for example, it is disclosed that the thermal conductivity of the compound oxide particle including zinc atoms is more than 1.7 W/m·K.

PTL 3 discloses a thermally conductive complex oxide having a spinel structure including MgAl₂O₄ or ZnAl₂O₄ as a main component obtained by firing a raw material containing at least an alumina compound and a magnesium or zinc compound as main components, in which the absolute value of the rate of change in mass in a chemical resistance test is 2% or less. Although evaluation of electrical insulation properties was conducted, dielectric properties were not evaluated, and the thermal conductivity is disclosed as 0.43 to 0.63 W/m·K in a condition that the complex oxide content was 50%.

### CITATION LIST

### Patent Literature

PTL 1: WO 2020/145342
PTL 2: WO 2018/207679
PTL 3: Japanese Unexamined Patent Application Publication No. 2016-135841

### SUMMARY OF INVENTION

### Technical Problem

As described above, spinel complex oxide particles are widely known as a thermally conductive filler, but there are few examples of spinel complex oxide particles that have both thermal conductivity and dielectric properties. Especially, gahnite particles have often drawn attention in terms of thermal conductivity and chemical resistance but not been fully investigated in terms of dielectric properties. Furthermore, the firing temperatures described in the above literatures are high, and there is still room for improvement in the production method.

An object of the present invention is to provide a gahnite particle with excellent thermal conductivity and dielectric properties, and to provide a method for easily producing the particle.

### Solution to Problem

The inventor of the present invention has conducted elaborate studies to achieve the above object. As a result, the inventor has found that gahnite particles including molybdenum have excellent thermal conductivity and dielectric properties and are produced more easily than conventional methods. This finding has led to completion of the invention.

Specifically, the present invention has the following aspects.
(1) A gahnite particle including zinc atoms, aluminum atoms, and oxygen atoms, and molybdenum atoms, wherein the gahnite particle has a dielectric loss tangent of 1.0×10⁻³ or less at 1 GHZ.
(2) The gahnite particle according to (1), wherein the gahnite particle has an average particle size of 0.1 to 15 μm.
(3) A method for producing the gahnite particle according to (1) or (2), including firing a zinc compound and an aluminum compound in the presence of a molybdenum compound.
(4) The method for producing the gahnite particle according to (3), including steps of:
(1) preparing an intermediate by heating a first mixture (A-1) containing a molybdenum compound and a zinc compound, or a first mixture (A-2) containing a molybdenum compound, a zinc compound, and an aluminum compound; and
(2) producing a gahnite particle by firing a second mixture containing the intermediate when the mixture (A-2) is used, or a second mixture containing the intermediate and an aluminum compound when the mixture (A-1) is used, at a temperature higher than a heating temperature selected in step (1).
(5) The method for producing the gahnite particle according to (3) or (4), including: a firing step of growing a zinc compound and an aluminum compound into a gahnite particle by solid solution formation and crystal formation in the presence of a molybdenum compound; and a cooling step of further crystallizing the gahnite particle grown in the firing step.
(6) The method according to (3) to (5), wherein a molar ratio of molybdenum atoms in the molybdenum compound to zinc atoms in the zinc compound (molybdenum atoms/zinc atoms) is 0.012 to 1.5.
(7) The method according to (3) to (6), wherein firing temperature is 800 to 1300° C.
(8) A resin composition containing the gahnite particle according to (1) or (2) and a resin.
(9) A molded product of the resin composition according to (8).

### Advantageous Effects of Invention

The present invention provides a gahnite particle with excellent thermal conductivity and dielectric properties.

### DESCRIPTION OF EMBODIMENTS

Hereinafter, embodiments for carrying out the present invention will be described in detail.

### <Gahnite Particles>

In the present invention, gahnite particles refer to gahnite particles including zinc atoms, aluminum atoms, and oxygen atoms, and molybdenum atoms. The gahnite particles have a dielectric loss tangent of 1.0×10⁻³ or less at 1 GHz.

Generally, gahnite particles are represented by ZnAl₂O₄, but the gahnite particle in the present invention means the entire particle including molybdenum atoms. The molybdenum atoms may be located on a surface of the gahnite particle, as described later. On the other hand, the molybdenum atoms may be located inside the gahnite particle. The molybdenum atoms may be located on a surface of and inside the gahnite particle.

Here, “located on a surface” means that molybdenum atoms are present on a gahnite particle surface in the form of attachment, coating, bonding, or other similar form. On the other hand, “located inside” means that molybdenum atoms are incorporated into a gahnite crystal or present in a space such as a defect in the gahnite crystal. “Incorporated into a gahnite crystal” means that at least some of the atoms constituting gahnite are replaced by molybdenum atoms, and the molybdenum atoms are included as a part of the gahnite crystal. In this case, the atoms of gahnite to be replaced are not limited and may be any of zinc atoms, aluminum atoms, and oxygen atoms.

The gahnite particles preferably have a dielectric constant of 13 or less, more preferably 10 or less, more preferably 9.7 or less, and particularly preferably 9.5 or less. The dielectric constant within the above range is preferred, because if so, power consumption, that is, heat generation can be suppressed and dielectric loss can be reduced when a resin composition is made.

The gahnite particles have a dielectric loss tangent of 1.0×10⁻³ or less at 1 GHz, preferably 9.0×10⁻⁴ or less, and more preferably 8.0×10⁻⁴ or less. The dielectric loss tangent within the above range is preferred, because if so, power consumption, that is, heat generation can be suppressed and dielectric loss can be reduced when a resin composition is made. More preferably, both the dielectric constant and the dielectric loss tangent are equal to or less than the above upper limits.

The gahnite particles preferably have an average particle size of 0.1 to 15 μm, more preferably 0.5 to 10 μm, and particularly preferably 1 to 5 μm. The average particle size of 0.1 μm or more is preferred, because if so, increase in viscosity of a resin composition obtained by mixing with a resin can be suppressed. On the other hand, the average particle size of 15 μm or less is preferred, because if so, when a resin composition obtained by mixing with a resin is molded, the surface of the resulting molded product is smooth or the mechanical properties of the molded product are excellent. The average particle size within the above range is preferred, because if so, the dielectric loss tangent is excellent.

In the present description, the “average particle size” of the gahnite particles is a value of D50 of a volume-based particle size distribution obtained by laser diffraction scattering particle size distribution analysis.

The gahnite particles have a shape such as a polyhedral, spherical, elliptical, cylindrical, polygonal, needle, rod, plate, disk, flake, or scale shape. Among these, the polyhedral, spherical, elliptical, and plate shapes are preferred because they are easily dispersed in a resin, and the polyhedral and spherical shapes are more preferred. The “polyhedral shape” usually has six or more facets, preferably eight or more facets, and more preferably 10 to 30 facets. The shape of the gahnite particles can be observed by a scanning electron microscope (SEM).

The particle shape refers to the shape of particles that account for 50% or more on a mass basis or a number basis. The proportion is more preferably 80% or more, and even more preferably 90% or more.

As described above, gahnite particles represent gahnite particles including zinc atoms, aluminum atoms, and oxygen atoms. The gahnite particles according to the present invention further include molybdenum atoms. The gahnite particles according to an embodiment may additionally include inevitable impurities, other atoms, and the like, as long as the effect of the present invention is not impaired.

### <Amount of Atoms>

### (Zinc Atoms, Aluminum Atoms, Oxygen Atoms)

The amounts of zinc atoms, aluminum atoms, and oxygen atoms in the gahnite particles are not limited. When the structural formula of gahnite is expressed as ZnAlₓO_{y}, x is preferably in the range of 1.8 to 2.2, and more preferably in the range of 1.9 to 2.1, and y is in the range of 3.7 to 4.3, and more preferably in the range of 3.85 to 4.15. The x above represents the molar ratio of aluminum atoms to zinc atoms (aluminum atoms/zinc atoms). In the present description, the amounts of zinc atoms and aluminum atoms in the gahnite particles are values measured by inductively coupled plasma optical emission spectrometry (ICP-OES).

### (Molybdenum Atoms)

Molybdenum atoms in the gahnite particles according to the present invention can be included due to the production method described later. The molybdenum atoms include molybdenum atoms in a molybdenum-containing compound described later.

The amount of molybdenum in the gahnite particles is not limited, but the molar ratio of molybdenum atoms to zinc atoms (molybdenum atoms/zinc atoms) is preferably 0.001 or more, and more preferably 0.07 or less. The molar ratio of molybdenum atoms to zinc atoms of 0.001 or more is preferred, because if so, the thermal conductivity of the gahnite particles is improved. The molar ratio of 0.07 or less is more preferred, because if so, highly crystalline gahnite particles can be obtained. In the present description, the amount of molybdenum atoms in the gahnite particles is a value measured by inductively coupled plasma optical emission spectrometry (ICP-OES).

### (Other Atoms)

Other atoms other than zinc atoms, aluminum atoms, oxygen atoms, and molybdenum atoms can be intentionally included in the gahnite particles, for example, for the purpose of coloring, light emission, and controlling the formation of gahnite particles to the extent that the effect of the present invention is not impaired. Examples include magnesium, calcium, strontium, barium, chromium, nickel, iron, copper, manganese, titanium, zirconium, cadmium, yttrium, lanthanum, gallium, and indium. These other atoms may be included alone or in a mixture of two or more.

The amount of other atoms other than zinc atoms, aluminum atoms, oxygen atoms, and molybdenum atoms in the gahnite particles is preferably 10 mol % or less with respect to the amount of zinc atoms in the gahnite particles, more preferably 5 mol % or less, and most preferably 2 mol % or less.

### (Inevitable Impurities)

Inevitable impurities are those that are present in raw materials or inevitably mixed into the gahnite particles during the production process, and mean impurities that are essentially unnecessary but are present in minute amounts and do not affect the characteristics of the gahnite particles.

Examples of the inevitable impurities include, but not limited to, silicon, iron, potassium, sodium, calcium, cadmium, and lead. These inevitable impurities may be included alone or two or more may be included.

The amount of inevitable impurities in the gahnite particles is preferably 10000 ppm or less, more preferably 1000 ppm or less, and even more preferably 10 ppm or more and 500 ppm or less with respect to the mass of the gahnite particles.

### <Method for Producing Gahnite Particles>

A method for producing a gahnite particle includes a step (1) of preparing an intermediate by heating a first mixture (A-1) containing a molybdenum compound and a zinc compound, or a first mixture (A-2) containing a molybdenum compound, a zinc compound, and an aluminum compound. The firing temperature in step (1) is lower than the temperature selected in step (2) described later.

### [Step (I) of Preparing Intermediate]

### (First Mixture)

The first mixture contains a molybdenum compound and a zinc compound as essential components. The first mixture used in the production method according to the present invention can be broadly classified as the first mixture (A-1) containing only a molybdenum compound and a zinc compound, or the first mixture (A-2) containing a molybdenum compound, a zinc compound, and an aluminum compound, as a raw material for the gahnite particles.

### (Molybdenum Compound)

Examples of the molybdenum compound include, but not limited to, molybdenum compounds such as metallic molybdenum, molybdenum oxide, molybdenum sulfide molybdenum, sodium molybdate, potassium molybdate, calcium molybdate, ammonium molybdate, H₃PMo₁₂O₄₀, and H₃SiMo₁₂O₄₀. In this case, the molybdenum compounds include isomers. For example, the molybdenum oxide may be molybdenum dioxide (IV) (MoO₂) or molybdenum trioxide (VI) (MoO₃). Among these, molybdenum trioxide, molybdenum dioxide, and ammonium molybdate are preferred, and molybdenum trioxide is more preferred.

The molybdenum compounds above may be used alone or in combination of two or more.

### (Zinc Compound)

Examples of the zinc compound include, but not limited to, zinc compounds such as zinc oxide, zinc hydroxide, zinc carbonate hydroxide, zinc nitrate, zinc acetate, and zinc chloride. Among these, zinc oxide is more preferred.

The zinc compounds above may be used alone or in combination of two or more.

The molar ratio of molybdenum atoms in the molybdenum compound to zinc atoms in the zinc compound (molybdenum atoms/zinc atoms) is preferably 0.012 to 1.5, and more preferably 0.05 to 1.3. The molar ratio of 0.012 or more is preferred, because if so, crystal growth can proceed suitably. On the other hand, the molar ratio of 1.5 or less is preferred in terms of productivity and production cost because the amount of molybdenum compound used can be reduced.

### (Aluminum Compound)

Examples of the aluminum compound include, but not limited to, aluminum derivatives such as metallic aluminum, alumina (aluminum oxide), aluminum hydroxide, aluminum sulfide, aluminum nitride, aluminum fluoride, aluminum chloride, aluminum bromide, and aluminum iodide; aluminum oxoacid salts such as aluminum sulfate, aluminum sodium sulfate, aluminum potassium sulfate, aluminum ammonium sulfate, aluminum nitrate, aluminum perchlorate, aluminum aluminate, aluminum silicate, and aluminum phosphate; aluminum organic salts such as aluminum acetate, aluminum lactate, aluminum laurate, aluminum stearate, and aluminum oxalate; alkoxyaluminum such as aluminum propoxide and aluminum butoxide; and hydrates thereof. Among these, aluminum oxide, aluminum hydroxide, aluminum chloride, aluminum sulfate, aluminum nitrate, and hydrates thereof are preferred, and aluminum oxide and aluminum hydroxide are more preferred.

The aluminum compounds above may be used alone or in combination of two or more.

The molar ratio of zinc atoms in the zinc compound to aluminum atoms in the aluminum compound to be blended when using the mixture (A-2) (aluminum atoms/zinc atoms) is preferably in the range of 2.2 to 1.8, and more preferably in the range of 2.1 to 1.9. The molar ratio in the range of 2.2 to 1.8 is preferred, because if so, unreacted zinc oxide and aluminum oxide are suppressed.

### <<Firing of First Mixture>>

When the mixture (A-1) is used, a zinc molybdate compound can be obtained by firing the zinc compound and the molybdenum compound.

In this case, the firing temperature is not limited as long as a zinc molybdate compound can be obtained. The firing temperature is preferably 500 to 1300° C., more preferably 600 to 1100° C., even more preferably 700 to 900° C. The firing temperature of 700° C. or higher is preferred, because if so, the molybdenum compound can react efficiently with the zinc compound.

On the other hand, the firing temperature of 900° C. or lower is preferred, because of industrial practicability.

The firing time is also not limited. The firing time is preferably 0.1 to 100 hours, and more preferably 1 to 10 hours.

After firing, the zinc molybdate compound may be temporarily isolated by cooling, or the firing step described later may be performed as it is.

When the mixture (A-2) is used, a zinc molybdate compound and an aluminum molybdate compound can be obtained by firing the zinc compound, the molybdenum compound, and the aluminum compound.

### (Intermediate)

The intermediate obtained by firing the first mixture contains the zinc molybdate compound as an essential component. When the first mixture is the mixture (A-1), the intermediate substantially contains the zinc molybdate compound as a main component. When the first mixture is the mixture (A-2), the intermediate substantially contains the zinc molybdate compound and the aluminum molybdate compound as main components.

### (Zinc Molybdate Compound)

The zinc molybdate compound is a source of molybdenum vapor in the firing step described later and has the function of providing metal atoms that form crystals with aluminum atoms in the aluminum compound.

The zinc molybdate compound contains zinc atoms, molybdenum atoms, and oxygen atoms and is generally represented by ZnMoO₄.

However, the zinc molybdate compound may have other compositions. For example, when the molar ratio of molybdenum atoms to zinc atoms is not 1:1, excess unreacted zinc or molybdenum compound is present after firing. In this case, a mixture of the zinc molybdate compound and the zinc compound or a mixture of the zinc molybdate compound and the molybdenum compound results. The zinc molybdate compound may contain other atoms.

### (Aluminum Molybdate Compound)

The aluminum molybdate contains aluminum atoms, molybdenum atoms, and oxygen atoms and is generally represented by Alₓ(MoO₄)_{y}. Here, both x and y are integers or decimals equal to or greater than 1. The aluminum molybdate compound can decompose to form alumina with high proportion of α-alumina.

### [Step of Producing Gahnite Particles]

### (Second Mixture)

A second mixture contains the intermediate and an aluminum compound. When the first mixture already contains an aluminum compound in the amount necessary to synthesize gahnite particles, the second mixture is the same as the above intermediate, except when other compounds described later are added.

In other words, when the mixture (A-2) is used as the first mixture, a second mixture containing the intermediate is used as the second mixture, while when the mixture (A-1) is used as the first mixture, a second mixture containing the intermediate and an aluminum compound is used as the second mixture.

The aluminum compound blended when the mixture (A-1) is used can be similar to the aluminum compound described above. When the aluminum compound is blended, the molar ratio of zinc atoms in the zinc molybdate compound to aluminum atoms (aluminum atoms/zinc atoms) is preferably in the range of 2.2 to 1.8, and more preferably in the range of 2.1 to 1.9.

The zinc molybdate may be prepared by the intermediate preparation step (I) described above, or may be a commercial product.

### <<Firing of Second Mixture>>

The gahnite particles can be obtained by firing the second mixture containing the intermediate, or the intermediate and the aluminum compound, at a temperature higher than the temperature selected in the intermediate preparation step (I).

The firing temperature is not limited as long as the desired gahnite particles can be obtained. The firing temperature is preferably 800 to 1300° C., more preferably 900 to 1200° C., and particularly preferably 1000 to 1100° C. The firing temperature of 800° C. or higher is preferred, because if so, highly crystalline gahnite particles can be obtained. On the other hand, the firing temperature of 1300° C. or lower is preferred, because if so, the zinc compounds is not volatilized.

The firing time is also not limited. The firing time is preferably 0.1 to 120 hours, and more preferably 1 to 50 hours. The firing time of 0.1 hour or longer is preferred, because if so, highly crystalline gahnite particles can be obtained. On the other hand, the firing time of 120 hours or shorter is preferred, because if so, the production cost can be reduced.

The firing atmosphere may be an air atmosphere, an inert gas atmosphere such as nitrogen gas or argon gas, an oxygen atmosphere, an ammonia gas atmosphere, or a carbon dioxide atmosphere. In this case, an air atmosphere is preferred in terms of production cost.

The pressure during firing is not limited. The firing may be performed under normal pressure, under increased pressure, or under reduced pressure, but preferably under normal pressure in terms of production cost.

The heating means is not limited, but a firing furnace is preferably used. Examples of the firing furnace used in this case include box furnaces, tunnel furnaces, roller hearth furnaces, rotary kilns, and muffle furnaces.

Conventional spinel complex oxide particles are usually synthesized by firing at high temperatures and therefore tend to suffer defect structures and the like, and it has been difficult to precisely control the crystal structures. In particular, in a high temperature range above 1300° C., which is the temperature at which sublimation of zinc compounds begins, defects seem to occur in some of the zinc sites of the synthesized gahnite particles. This may be the reason why the dielectric properties are reduced.

On the other hand, in a low-temperature region below 1300° C., the ratio between aluminum atoms and zinc atoms in gahnite crystals is uneven, and high crystallinity fails to be obtained. This seems to reduce the dielectric properties. However, when a predetermined amount of a molybdenum compound is fired simultaneously, the ratio between aluminum atoms and zinc atoms in the gahnite crystals becomes uniform, resulting in gahnite particles with high crystallinity, although the reason is not clear.

### [Firing Step by Solid Solution Formation and Crystal Formation]

According to one embodiment of the present invention, the gahnite particles can be produced by solid solution formation and crystal formation by firing a third mixture of a zinc-containing compound and an aluminum compound in the presence of molybdenum atoms.

Here, the third mixture containing an aluminum source and a molybdenum compound is fired to form aluminum molybdate, which is an intermediate compound, the aluminum molybdate compound decomposes, and the molybdenum compound evaporates, resulting in an aluminum compound containing molybdenum. In this case, the evaporation of the molybdenum compound serves as a driving force for the crystal growth of the aluminum compound containing molybdenum.

The solid solution formation and crystal formation are usually performed by a method called solid-phase process. Specifically, the zinc-containing compound and the aluminum compound react at the interface to form nuclei, and zinc atoms and/or aluminum atoms diffuse in solid phase through the nuclei and react with the aluminum compound and/or the zinc atom-containing compound. Thus, dense crystals, that is, gahnite particles can be obtained. In the solid phase diffusion described above, since the diffusion rate of zinc atoms into the aluminum compound is relatively higher than the diffusion rate of aluminum atoms into the zinc atom-containing compound, the gahnite particles that reflect the shape of the aluminum compound tend to be obtained. The shape and the average particle size of the gahnite particles therefore can be controlled by changing the shape and the average particle size of the aluminum compound as appropriate.

Here, the solid phase reaction is performed in the presence of molybdenum. In gahnite particles having a plurality of metal components, it is difficult to precisely control the crystal structure because defect structures and the like tend to occur during the firing step. By using molybdenum, however, the crystal structure of the gahnite crystals can be controlled. Since the solid phase reaction is performed in the presence of molybdenum, the resulting gahnite particles can contain molybdenum.

The aluminum compound preferably contains molybdenum. In this case, the form of inclusion of molybdenum in the aluminum compound containing molybdenum is not limited. Examples of the form include a form in which molybdenum is located on the aluminum compound surface in the form of attachment, coating, bonding, or other similar form, a form in which molybdenum is incorporated into the aluminum compound, and a combination of these forms, in the same manner as the gahnite particles. In this case, the “form in which molybdenum is incorporated into the aluminum compound” includes, for example, a form in which at least some of the atoms constituting the aluminum compound are replaced by molybdenum, and a form in which molybdenum is located in a space that may exist in the crystals of the aluminum compound (including a space created by defects in the crystal structure, etc.). In the form of being replaced, the atoms constituting the aluminum compound to be replaced are not limited and may be any of aluminum atoms, oxygen atoms, and other atoms.

Among the aluminum compounds described above, it is preferable to use the aluminum compound containing molybdenum, and it is more preferable to use the aluminum compound in which molybdenum is incorporated.

The reason why the aluminum compound containing molybdenum is preferred is not necessarily clear, but the following mechanism can be presumed. The molybdenum contained in the aluminum compound seems to serve the functions such as promoting nucleation at the solid phase interface and promoting solid phase diffusion of aluminum atoms and zinc atoms, and the solid phase reaction between the aluminum compound and the zinc compound proceeds more suitably. In other words, as described later, the aluminum compound containing molybdenum can have the functions of aluminum compound and molybdenum. In particular, the aluminum compound in which molybdenum is incorporated has molybdenum located directly or in close proximity to the reaction point and exhibits the effect of molybdenum more effectively. The above mechanism is only presumption, and even a mechanism that is different from the above mechanism and achieves the desired effect is included in the technical scope.

The aluminum compound containing molybdenum can be prepared by the flux method.

### [Cooling Step]

A cooling step is a step of cooling the gahnite particles grown into crystals in the firing step, and crystallizing the gahnite particles into a particulate state.

The cooling rate is preferably, but not limited to, 1 to 1000° C./hour, more preferably 5 to 500° C./hour, and even more preferably 50 to 100° C./hour. The cooling rate of 1° C./hour or more is preferred, because if so, the production time can be reduced. On the other hand, the cooling rate of 1000° C./hour or less is preferred, because if so, a firing container is less likely to crack due to heat shock and can be used longer.

The cooling method is not limited, and the cooling may be natural cooling or by using cooling equipment.

The production method according to the present invention may include a post-treatment step. The post-treatment step is a step of removing additives and the like. The post-treatment step may be performed after the firing step, may be performed after the cooling step, or may be performed after the firing step and the cooling step. The post-treatment step may be repeated two or more times, if necessary.

Examples of methods of the post-treatment include washing and high-temperature treatment. These can be performed in combination.

The washing method is not limited. For example, the additives and the like can be removed by washing with water, an aqueous ammonia solution, an aqueous sodium hydroxide solution, an aqueous acidic solution, or the like.

In this case, the amount of molybdenum can be controlled by changing the concentration and amount of water, an aqueous ammonia solution, an aqueous sodium hydroxide solution, or an aqueous acidic solution used, as well as the washing site and washing time, as appropriate.

As the high-temperature treatment method, the temperature may be increased above the sublimation point or the boiling point of the additives.

### [Pulverizing Step]

The gahnite particles obtained by firing may aggregate and not meet the suitable range of particle size according to the present invention. In this case, the particles may be pulverized to meet the suitable range of particle size according to the present invention, if necessary.

The method of pulverizing is not limited. Conventionally known pulverizing methods such as ball mill, jaw crusher, jet mill, disk mill, Spectromill, grinder, and mixer mill can be employed.

### [Classification Step]

The gahnite particles are preferably classified in order to adjust the average particle size and to improve the flowability of powder, or to suppress increase in viscosity when blended with a binder to form a matrix. The “classification” refers to the operation of grouping the particles according to the size of particles.

The classification method may be either wet classification or dry classification. In terms of productivity, dry classification is preferred. The dry classification includes sieve classification and wind classification in which particles are classified using a centrifugal force and a difference in fluid resistance. In terms of classification accuracy, wind classification is preferred and can be performed using a classifier such as an airflow classifier using the Coanda effect, a swirling airflow classifier, a forced vortex centrifugal classifier, or a semi-free vortex centrifugal classifier.

The pulverizing step and the classification step can be performed at any necessary stage, including before and after an organic compound layer formation step described later. For example, the average particle size of the resulting gahnite particles can be adjusted by the presence or absence of the pulverizing and classification steps and the selection of their conditions.

### <Resin Composition>

According to an embodiment of the present invention, a composition containing gahnite particles and a resin is provided. In this case, the composition may further contain curing agent, curing catalyst, viscosity modifier, plasticizer, and the like, if necessary.

### (Gahnite Particles)

As the gahnite particles, the gahnite particles described above in the section “Gahnite Particles” can be used and will not be further described here.

The gahnite particles surface-treated by the method described below may be used. The surface treatment can further improve the thermal conductivity of the gahnite particles.

For example, the surface-treated gahnite particles can be produced from the gahnite particles obtained as described above by attaching surface treatment layer containing an organic compound to at least a part of the gahnite particle surface.

Specifically, the surface-treated gahnite particles can be produced by mixing untreated gahnite particles with a surface treatment agent that can form the surface treatment layer containing an organic compound, attaching the surface treatment agent to at least parts of the surfaces of the untreated gahnite particles, and then performing, for example, drying or curing.

If the surface treatment agent itself is an organic compound that does not have reactivity but has adsorption properties, or if the surface treatment agent is a solution or dispersion in which the surface treatment agent is dissolved or dispersed in a liquid medium, drying may be performed to promote adsorption or remove the liquid medium. If the surface treatment agent is an organic compound that has reactivity, curing based on a reactive group of the compound may be performed to form the surface treatment layer. If the surface treatment agent is attached to the entire surfaces of the untreated gahnite particles, the untreated gahnite particles are coated with the surface treatment layer.

The surface treatment agent is preferably a non-polar silane compound. Non-polarity prevents deterioration of dielectric properties because of the absence of polar substituents. The polar substituents are groups capable of hydrogen bonding or ion-dissociative groups. Examples of such polar substituents include, but not limited to, —OH, —COOH, —COOM, —NH₃, —NR₄⁺A⁻, and —CONH₂. Here, M is a cation of alkali metal, alkaline earth metal, quaternary ammonium salt, or the like, R is H or a hydrocarbon group with eight or less carbon atoms, and A is an anion of a halogen atom or the like.

The treatment method with the surface treatment agent may be a known customary method. Examples of the treatment method include spraying methods using fluid nozzles, dry methods such as stirring with shear force, ball mills, and mixers, and wet methods such as aqueous or organic solvent-based methods. It is desirable that the surface treatment using shear force is performed to the extent that the filler does not break.

The system temperature in the dry methods for the surface treatment agent or the drying or curing temperature after the treatment in the wet methods is determined as appropriate in the range in which no thermal decomposition occurs, depending on the type of surface treatment agent. For example, heating at temperatures of 80 to 230° C. is desirable.

The amount of non-volatile content or cured product of the surface treatment agent in the surface treatment layer relative to the untreated gahnite particles is not limited, but the amount of non-volatile content or cured product in the surface treatment agent is preferably 0.01 to 10 parts per 100 parts by mass of the untreated gahnite particles to improve the functions such as thermal conductivity as described above.

Whether unknown gahnite particles correspond to the surface-treated gahnite particles according to the present invention can be determined based on, for example, whether a chemical structure corresponding to the surface treatment agent itself or its cured product, or the presence of silicon, titanium, or phosphorus atoms, which are indicators, can be observed in an extract solution obtained by immersing or boiling the unknown gahnite particles in a solvent that dissolves the non-volatile content or the cured product of the surface treatment agent or in the gahnite particle surface itself, by infrared absorption spectrometry (IR) or atomic absorption spectrometry (AA).

In the state in which the surface treatment layer is attached to at least parts of the surfaces of the untreated gahnite particles, the wettability with the resin contained in a resin composition is improved and the adhesiveness to the gahnite particles is improved. This suppresses the formation of voids that tend to occur on the gahnite particle surface, thereby reducing loss in thermal conductivity. As a result, for example, the thermal conductivity of a molded product of the resin composition can be improved. Such a technical effect is achieved when the surface treatment agent based on an organic compound or the surface treatment layer based on the cured product of the surface treatment agent is attached to parts of the surfaces of the gahnite particles, and is not achieved when the surface treatment agent is removed from the gahnite particles, for example, by firing after the surface treatment.

When different types of gahnite particles are used, gahnite particles having a surface treatment layer can be used as one or more of these different types.

### (Resin)

Examples of the resin include, but not limited to, thermoplastic resin and thermosetting resin.

The thermoplastic resin is not limited, and any known customary resin used for molding materials can be used. Specifically, examples of the thermoplastic resin include polyethylene resin, polypropylene resin, polymethyl methacrylate resin, polyvinyl acetate resin, ethylene-propylene copolymer, ethylene-vinyl acetate copolymer, polyvinyl chloride resin, polystyrene resin, polyacrylonitrile resin, and polyamide resin. Other examples include polycarbonate resin, polyacetal resin, polyethylene terephthalate resin, polyphenylene oxide resin, polyphenylene sulfide resin, polysulfone resin, polyethersulfone resin, polyetheretherketone resin, polyarylsulfone resin, thermoplastic polyimide resin, thermoplastic urethane resin, polyamino bismaleimide resin, polyamideimide resin, polyetherimide resin, bismaleimide triazine resin, polymethylpentene resin, fluoride resin, liquid crystal polymer, olefin-vinyl alcohol copolymer, ionomer resin, polyarylate resin, acrylonitrile-ethylene-styrene copolymer, acrylonitrile-butadiene-styrene copolymer, and acrylonitrile-styrene copolymer.

The thermosetting resin is a resin characterized by being able to become substantially insoluble and infusible when cured by heating or by such means as radiation or catalyst. Typically, known customary resins used for molding materials can be used. Specifically, examples of the thermosetting resin include phenolic resin, epoxy resin, urea resin, resin having a triazine ring, (meth)acrylic resin, vinyl resin, unsaturated polyester resin, bismaleimide resin, polyurethane resin, diallyl phthalate resin, silicone resin, resin having a benzoxazine ring, and cyanate ester resin. Examples of the phenolic resin include novolac-type phenolic resin and resol-type phenolic resin. Examples of the novolac-type phenolic resin include phenol novolac resin and cresol novolac resin. Examples of the resol-type phenolic resin include unmodified resol phenolic resin and oil-modified resol phenolic resin. Examples of oil used for oil modification include tung oil, linseed oil, and walnut oil. Examples of the epoxy resin include bisphenol-type epoxy resin, fatty chain-modified bisphenol-type epoxy resin, novolac-type epoxy resin, biphenyl-type epoxy resin, and polyalkylene glycol-type epoxy resin. Examples of the bisphenol-type epoxy resin include bisphenol A epoxy resin and bisphenol F epoxy resin. Examples of the novolac-type epoxy resin include novolac epoxy resin and cresol novolac epoxy resin. Examples of the resin having a triazine ring include melamine resin. Examples of the vinyl resin include vinyl ester resin.

The resins listed above may be used alone or in combination of two or more. In this case, two or more thermoplastic resins may be used, two or more thermosetting resins may be used, or one or more thermoplastic resins and one or more thermosetting resins may be used.

### (Curing Agent)

The curing agent is not limited and any known curing agent can be used. Specific examples of the curing agent include amine compound, amide compound, acid anhydride compound, and phenolic compound.

Examples of the amine compound include diaminodiphenylmethane, diethylenetriamine, triethylenetetramine, diaminodiphenylsulfone, isophoronediamine, imidazole, BF3-amine complex, and guanidine derivative.

Examples of the amide compound include dicyandiamide and polyamide resin synthesized from a dimer of linolenic acid and ethylenediamine.

Examples of the acid anhydride compound include phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, and methylhexahydrophthalic anhydride.

Examples of the phenolic compound include phenol novolac resin, cresol novolac resin, aromatic hydrocarbon formaldehyde resin-modified phenolic resin, dicyclopentadiene phenol addition-type resin, phenol aralkyl resin (xylok resin), polyhydric phenol novolac resin synthesized from a polyhydric hydroxyl compound such as resorcin novolac resin and formaldehyde, naphthol aralkyl resin, trimethylolmethane resin, tetraphenylolethane resin, naphthol novolac resin, naphthol-phenol co-condensed novolac resin, naphthol-cresol co-condensed novolac resin, polyhydric phenol compounds such as biphenyl-modified phenolic resin (polyhydric phenol compound in which phenol nuclei are linked via a bismethylene group), biphenyl-modified naphthol resin (polyhydric naphthol compound in which phenol nuclei are linked via a bismethylene group), amino triazine-modified phenolic resin (polyhydric phenol compound in which phenol nuclei are linked via melamine, benzoguanamine, etc.), and alkoxy group-containing aromatic ring-modified novolac resin (polyhydric phenol compound in which a phenol nucleus and an alkoxy group-containing aromatic ring are linked via formaldehyde).

The curing agents above may be used alone or in combination of two or more.

### (Curing Accelerator)

A curing accelerator has the function of accelerating curing when the resin composition is cured.

Examples of the curing accelerator include, but not limited to, phosphorus compound, tertiary amine, imidazole, organic acid metal salt, Lewis acid, and amine complex salt.

The curing accelerators above may be used alone or in combination of two or more.

### (Curing Catalyst)

The curing catalyst has the function of allowing a curing reaction of a compound having a polymerizable functional group to proceed, instead of the curing agent.

The curing catalyst is not limited, and any known customary thermal polymerization initiators and active energy ray polymerization initiators can be used.

The curing catalysts may be used alone or in combination of two or more types.

### (Viscosity Modifier)

The viscosity modifier has the function of adjusting the viscosity of the resin composition.

The viscosity modifier is not limited and examples include organic polymer, polymer particles, and inorganic particles.

The viscosity modifiers above may be used alone or in combination of two or more.

### (Plasticizer)

The plasticizer has the function of improving the processability, flexibility, and weather resistance of thermoplastic synthetic resins.

The plasticizer is not limited and for example, phthalate, adipate, phosphate, trimellitate, polyester, polyolefin, polysiloxane, or the like may be used.

The plasticizers above may be used alone or in combination of two or more.

### [Mixing]

The resin composition according to the present invention is obtained by mixing the gahnite particles with a resin and, if necessary, other ingredients. The mixing method is not limited, and any known customary mixing method can be employed.

When the resin is a thermosetting resin, a typical method for mixing the thermosetting resin and the gahnite particles is a method in which a predetermined amount of thermosetting resin, the gahnite particles, and, if necessary, other ingredients are mixed well using a mixer or the like, and the mixture is then kneaded with a triple roll or the like to obtain a liquid composition having flowability. A method for mixing the thermosetting resin and the gahnite particles according to another embodiment is a method in which a predetermined amount of thermosetting resin, the gahnite particles, and, if necessary, other ingredients are mixed well using a mixer or the like, and then the mixture is melt-kneaded using a mixing roll, an extruder, or the like and then cooled to obtain a solid composition. When the curing agent, the catalyst, and the like are blended, the mixed state is not limited as long as the curable resin and these ingredients are uniformly mixed well, but it is more preferable that the gahnite particles are also uniformly dispersed and mixed.

The amount of gahnite particles is preferably 5% by volume or more and 95% by volume or less relative to the volume of the resin composition, more preferably 20% by volume or more and 90% by volume or less, and particularly preferably 30% by volume or more and 80% by volume or less. When the amount of gahnite particles is equal to or more than the lower limit, more excellent thermal conductivity and dielectric properties can be imparted to the resin composition. On the other hand, when the amount of gahnite particles is equal to or less than the upper limit, the compound is excellent in thermal conductivity and flowability and can be molded easily.

When the resin is a thermoplastic resin, a typical method for mixing the thermoplastic resin, the gahnite particles, and the like is a method in which the thermoplastic resin, the gahnite particles, and, if necessary, other ingredients are pre-mixed using various mixers such as tumbler or Henschel mixer, and the mixture is melt-kneaded using a mixer such as Bunbury mixer, roll, Brabender, single-screw extruder, twin-screw extruder, kneader, or mixing roll. The temperature of the melt kneading is not limited, but is usually 100° C. or higher and 320° C. or lower.

A coupling agent may be externally added to the resin composition in order to further enhance the flowability of the resin composition and the filling properties of the filler such as gahnite particles. The external addition of the coupling agent can further enhance the adhesiveness between the resin and the gahnite particles, decrease the interfacial thermal resistance between the resin and the gahnite particles, and improve the thermal conductivity of the resin composition.

Examples of the coupling agent include organosilane compound.

Examples of the organosilane compound include alkyl trimethoxysilanes in which the alkyl group has 1 to 22 carbon atoms, such as methyltrimethoxysilane, dimethyldimethoxysilane, ethyltrimethoxysilane, ethyltriethoxysilane, n-propyltrimethoxysilane, n-propyltriethoxysilane, iso-propyltrimethoxysilane, iso-propyltriethoxysilane, pentyltrimethoxysilane, hexyltrimethoxysilane, and octenyltrimethoxysilane; 3,3,3-trifluoropropyltrimethoxysilane; alkyl trichlorosilanes in which the alkyl group has 1 to 22 carbon atoms, such as (tridecafluoro-1,1,2,2-tetrahydrooctyl)trichlorosilane; phenyltrimethoxysilane, phenyltriethoxysilane, p-chloromethylphenyltrimethoxysilane, p-chloromethylphenyltriethoxysilane; epoxysilanes such as γ-glycidoxypropyltrimethoxysilane, γ-glycidoxypropyltriethoxysilane, β-(3,4-epoxycyclohexyl)ethyltrimethoxysilane, and glycidoxyoctyltrimethoxysilane; aminosilanes such as γ-aminopropyltriethoxysilane, N-β (aminoethyl) γ-aminopropyltrimethoxysilane, N-β (aminoethyl) γ-aminopropylmethyldimethoxysilane, γ-aminopropyltrimethoxysilane, and γ-ureidopropyltriethoxysilane; mercaptosilanes such as 3-mercaptopropyltrimethoxysilane; vinylsilanes such as p-styryltrimethoxysilane, vinyltrichlorosilane, vinyltris(β-methoxyethoxy) silane, vinyltrimethoxysilane, vinyltriethoxysilane, γ-methacryloxypropyltrimethoxysilane, and methacryloxyoctyltrimethoxysilane; silazanes such as 1,3-diphenyltetramethyldisilazane, 1,3-divinyl-1,1,3,3-tetramethyldisilazane, and 1,1,1,3,3,3-hexamethyldisilazane, and epoxy, amino, and vinyl-based polymer-type silanes. The organosilane compounds above may be included alone or two or more of them may be included.

The coupling agents listed above may be used alone or in combination of two or more.

The amount of coupling agent added is preferably, but not limited to, 0.01% by mass or more and 5% by mass or less with respect to the mass of the resin, and more preferably 0.1% by mass or more and 3% by mass or less.

### <Use>

According to one embodiment of the present invention, the resin composition according to the present invention is used for low dielectric heat dissipation materials.

In general, alumina is often used as a thermally conductive material from a cost perspective, and other materials such as boron nitride, aluminum nitride, magnesium oxide, and magnesium carbonate have been used. However, with these materials, for example, aluminum oxide has insufficient dielectric properties. Boron nitride has anisotropy due to its crystal structure and therefore does not have uniform dielectric properties in the resin composition. Aluminum nitride, magnesium oxide, and magnesium carbonate have low water resistance and have insufficient dielectric properties. A material having both thermal conductivity and dielectric properties had not been found.

In contrast, the gahnite particles according to the present invention seem to have unprecedentedly high crystallinity and have a uniform ratio between aluminum atoms and zinc atoms in the crystal, and thereby have both thermal conductivity and dielectric properties. The resin composition according to the present invention is suitable for use in low dielectric heat dissipation materials.

Because of excellent thermal conductivity and dielectric properties, the resin composition according to the present invention can be used as a base material or substrate for mono-layer or multi-layer printed circuit boards, flexible printed circuit boards, and the like. Further, the resin composition according to the present invention can be suitably used as an insulating material for wiring, especially for high-frequency signal wiring, for example, cover lay, solder resist, build-up material, interlayer insulating agent, bonding sheet, interlayer adhesive, or bump sheet for flip chip bonder.

In addition, the gahnite particles can be used for jewelry, catalyst carrier, adsorbent, photocatalyst, optical material, phosphor, heat-resistant insulating material, substrate, sensor, and other applications.

According to one aspect of the present invention, a molded product made by molding the resin composition described above is provided. Since the gahnite particles according to the invention contained in the molded product have excellent thermal conductivity and dielectric properties, the molded product is preferably used as a low dielectric heat dissipation member. This can improve the heat dissipation function of devices, contributing not only to reduced size and weight and higher performance of the devices, but also to higher functionality of the communication function in high-frequency circuits.

### EXAMPLES

The present invention will be further detailed below based on examples, but this description is not intended to limit the present invention. In the examples, the values are in terms of mass unless otherwise noted.

### (Identification of Gahnite)

Gahnite particles can be identified by performing X-ray diffraction (XRD) analysis using a powder X-ray diffraction system, and comparing the result with a single crystal chart in the JCPDS card of the corresponding composition.

### (Synthesis of Gahnite Particles)

### Example 1

A mixture was obtained by mixing 13.8 g of molybdenum trioxide (from NIPPON INORGANIC COLOUR & CHEMICAL Co., Ltd.), 61.1 g of zinc oxide (from KANTO CHEMICAL CO., INC., special grade), and 90.0 g of boehmite (from KAWAI LIME INDUSTRY Co., Ltd., BMT-3LV, average particle size 2.6 μm), using ABSOLUTE MILL (from OSAKA CHEMICAL Co., Ltd.). The resulting mixture was placed in an alumina square saggar, heated to 1100° C. in an electric furnace at 5° C./minute, and held at 1100° C. for five hours for firing. The temperature was then lowered to room temperature at 5° C./minute, and then the saggar was removed, resulting in 144 g of a white fired product. The resulting fired product was disaggregated in a ball mill for 60 minutes with 200 g of 10 mm diameter alumina beads and 200 cc of water per 100 g of the fired product. Thereafter, the molybdenum compound was removed with 2N NaOH aqueous solution, and the powder was dried at 120° C. The dried powder was passed through a 125 μm sieve. The powder was identified as gahnite by XRD analysis.

### Example 2

A mixture was obtained by mixing 13.8 g of molybdenum trioxide (from NIPPON INORGANIC COLOUR & CHEMICAL Co., Ltd.), 61.1 g of zinc oxide (from HAKUSUI TECH Co., Ltd., zinc oxide grade 2), and 90.0 g of boehmite (from KAWAI LIME INDUSTRY Co., Ltd., BMT-3LV, average particle size 2.6 μm), using ABSOLUTE MILL (from OSAKA CHEMICAL Co., Ltd.). The resulting mixture was placed in an alumina square saggar, heated to 900° C. in an electric furnace at 5° C./minute, and held at 900° C. for five hours for firing. The temperature was then lowered to room temperature at 5° C./minute, and then the saggar was removed, resulting in 144 g of a white fired product. The resulting fired product was disaggregated in a ball mill for 60 minutes with 200 g of 10 mm diameter alumina beads and 200 cc of water per 100 g of the fired product. Thereafter, the molybdenum compound was removed with 2N NaOH aqueous solution, and the powder was dried at 120° C. The dried powder was passed through a 125 μm sieve. The powder was identified as gahnite by XRD analysis.

### Example 3

A mixture was obtained by mixing 13.8 g of molybdenum trioxide (from NIPPON INORGANIC COLOUR & CHEMICAL Co., Ltd.), 61.1 g of zinc oxide (from HAKUSUI TECH Co., Ltd., zinc oxide grade 2), and 90.0 g of boehmite (from KAWAI LIME INDUSTRY Co., Ltd., BMB-2, average particle size 1.2 μm), using ABSOLUTE MILL (from OSAKA CHEMICAL Co., Ltd.). The resulting mixture was placed in an alumina square saggar, heated to 900° C. in an electric furnace at 5° C./minute, and held at 900° C. for five hours for firing. The temperature was then lowered to room temperature at 5° C./minute, and then the saggar was removed, resulting in 144 g of a white fired product. The resulting fired product was disaggregated in a ball mill for 60 minutes with 200 g of 10 mm diameter alumina beads and 200 cc of water per 100 g of the fired product. Thereafter, the molybdenum compound was removed with 2N NaOH aqueous solution, and the powder was dried at 120° C. The dried powder was passed through a 125 μm sieve. The powder was identified as gahnite by XRD analysis.

### Example 4

A mixture was obtained by mixing 13.8 g of molybdenum trioxide (from NIPPON INORGANIC COLOUR & CHEMICAL Co., Ltd.), 61.1 g of zinc oxide (from HAKUSUI TECH Co., Ltd., zinc oxide grade 2), and 90.0 g of boehmite (from TAIMEI CHEMICALS Co., Ltd., C06, average particle size 0.7 μm), using ABSOLUTE MILL (from OSAKA CHEMICAL Co., Ltd.). The resulting mixture was placed in an alumina square saggar, heated to 1000° C. in an electric furnace at 5° C./minute, and held at 1000° C. for five hours for firing. The temperature was then lowered to room temperature at 5° C./minute, and then the saggar was removed, resulting in 144 g of a white fired product. The resulting fired product was disaggregated in a ball mill for 60 minutes with 200 g of 10 mm diameter alumina beads and 200 cc of water per 100 g of the fired product. Thereafter, the molybdenum compound was removed with 2N NaOH aqueous solution, and the powder was dried at 120° C. The dried powder was passed through a 125 μm sieve. The powder was identified as gahnite by XRD analysis.

### Comparative Example 1

A mixture was obtained by mixing 13.8 g of molybdenum trioxide (from NIPPON INORGANIC COLOUR & CHEMICAL Co., Ltd.), 61.1 g of zinc oxide (from KANTO CHEMICAL CO., INC., special grade), and 90.0 g of boehmite (from KAWAI LIME INDUSTRY Co., Ltd., BMT-3LV, average particle size 2.6 μm), using ABSOLUTE MILL (from OSAKA CHEMICAL Co., Ltd.). The resulting mixture was placed in an alumina square saggar, heated to 1500° C. in an electric furnace at 5° C./minute, and held at 1500° C. for five hours for firing. The temperature was then lowered to room temperature at 5° C./minute, and then the saggar was removed, resulting in 141 g of white fired product. The resulting fired product was disaggregated in a ball mill for 60 minutes with 200 g of 10 mm diameter alumina beads and 200 cc of water per 100 g of the fired product. Thereafter, the powder was dried at 120° C. The dried powder was passed through a 125 μm sieve. The powder was identified as gahnite by XRD analysis.

### Comparative Example 2

Powder was obtained by feeding and stirring 100 g of aluminum hydroxide (from Nippon Light Metal Company, Ltd., BF103, average particle size 1.0 μm), 184 g of zinc sulfate heptahydrate (from KANTO CHEMICAL CO., INC., special grade), 84.8 g of sodium carbonate, and 1000 g of water, washing the resulting precipitate with water, and drying at 120° C. The powder was mixed using ABSOLUTE MILL (from OSAKA CHEMICAL Co., Ltd.) to obtain a mixture. The resulting mixture was placed in an alumina square saggar, heated to 1300° C. in an electric furnace at 5° C./minute, and held at 1300° C. for five hours for firing. The temperature was then lowered to room temperature at 5° C./minute, and then the saggar was removed, resulting in 117 g of white fired product. The resulting fired product was disaggregated in a ball mill for 60 minutes with 200 g of 10 mm diameter alumina beads and 200 cc of water per 100 g of the fired product. Thereafter, the powder was dried at 120° C. The dried powder was passed through a 125 μm sieve. The powder was identified as gahnite by XRD analysis.

### Comparative Example 3

A mixture was obtained by mixing 76.5 g of alumina (from Denka Company Limited, DAW-05, average particle size 6.8 μm) and 61.1 g of zinc oxide (from KANTO CHEMICAL CO., INC., special grade) using ABSOLUTE MILL (from OSAKA CHEMICAL Co., Ltd.). The resulting mixture was placed in an alumina square saggar, heated to 1000° C. in an electric furnace at 5° C./minute, and held at 1000° C. for five hours for firing. The temperature was then lowered to room temperature at 5° C./minute, and then the saggar was removed, resulting in 141 g of white fired product. The resulting fired product was disaggregated in a ball mill for 60 minutes with 200 g of 10 mm diameter alumina beads and 200 cc of water per 100 g of the fired product. Thereafter, the powder was dried at 120° C. The dried powder was passed through a 125 μm sieve. The powder was identified as a mixture of gahnite and transition alumina by XRD analysis.

### [Evaluation Method]

The resulting gahnite particles were measured and evaluated according to the following methods.

### (Measurement of Dielectric Properties)

The gahnite particles obtained in Examples and Comparative Examples were charged as test specimens in a cavity resonator CP-001-PW from EM Labs, Inc., and measured with a network analyzer P9373A from Keysight Technologies to determine the dielectric constant and the dielectric loss tangent at 1 GHz.

### (Average Particle Size)

A small amount of the gahnite particle powder obtained in Examples and Comparative Examples was put into a beaker, to which 50 mL of 0.5% sodium hexametaphosphate aqueous solution was added. Thereafter, the solution was subjected to a dispersion process for two minutes using an ultrasonic homogenizer Sonifier 450D (BRANSON) to prepare a measurement sample. The volume-based cumulative D50 of the measurement sample was determined using a laser diffraction scattering particle size distribution analyzer MT3300EXII (from MicrotracBEL Corp.).

### (Analysis of Amounts of Aluminum Atoms, Zinc Atoms, and Molybdenum Atoms in Gahnite Particles)

The amounts of aluminum atoms, zinc atoms, and molybdenum atoms were determined using an ICP optical emission spectrometer iCAP 6300 DUO (from Thermo Fisher Scientific). The amount below a detection limit is denoted as N.D. (Not Detected). When the amount of molybdenum atoms is below the detection limit, the molar ratio between molybdenum atoms and zinc atoms is regarded as 0.

TABLE 1

| | | | Average | ICP | | | | |
|---|---|---|---|---|---|---|---|---|
| | | | particle | | | | Aluminum | Molybdenum |
| | | Dielectric | size | Amount of | Amount | Amount of | atoms/zinc | atoms/zinc |
| | Dielectric | loss | D50 | aluminum | of zinc | molybdenum | atoms | atoms |
| | constant | tangent | μm | mg/kg | mg/kg | mg/kg | (molar ratio) | (molar ratio) |
| Ex. 1 | 9.20 | 6.0 × 10⁻⁴ | 3.1 | 290000 | 350000 | 6300 | 2.01 | 0.012 |
| Ex. 2 | 10.0 | 3.5 × 10⁻⁴ | 2.8 | 291000 | 352000 | 6400 | 2.00 | 0.012 |
| Ex. 3 | 10.1 | 1.9 × 10⁻⁴ | 1.8 | 290000 | 351000 | 6600 | 2.00 | 0.012 |
| Ex. 4 | 10.4 | 9.9 × 10⁻⁴ | 0.7 | 286000 | 350000 | 7000 | 1.98 | 0.014 |
| Comp. | 9.30 | 1.2 × 10⁻³ | 4.0 | 300000 | 370000 | 6400 | 1.96 | 0.012 |
| Ex. 1 | | | | | | | | |
| Comp | 9.80 | 2.5 × 10⁻³ | 4.1 | 290000 | 355000 | N.D. | 1.98 | 0 |
| Ex. 2 | | | | | | | | |
| Comp. | 11.4 | 4.6 × 10⁻³ | 9.4 | 295000 | 355000 | N.D. | 2.04 | 0 |
| Ex. 3 | | | | | | | | |

### (Preparation of Resin Composition)

### Example 5

As a thermoplastic resin, 30.7 g of DIC-PPS LR100G (X-1, polyphenylene sulfide resin from DIC Corporation, density 1.35 g/cm³) and 69.3 g of the gahnite particles obtained in Example 1 were dry-blended uniformly and then melt-kneaded using a resin melt-kneading device Labo Plastomill at a kneading temperature of 300° C. and a rotation speed of 80 rpm to obtain a polyphenylene sulfide resin composition with 40% by volume of the particles. The filler content (% by volume) in the resin composition was calculated from the density of the thermoplastic resin and the density of the thermally conductive filler.

### (Method of Measuring Thermal Conductivity of Thermoplastic Resin Composition)

The resulting resin composition was injection-molded using a tabletop injection molding machine (Injection Moulder IM 12 from Xplore Instruments BV) at a cylinder temperature of 320° C. and a mold temperature of 140° C. to produce a test piece of 10 mm in diameter and 0.2 mm in thickness. The thermal conductivity was measured at 25° C. using a thermal conductivity measuring device (LFA467 HyperFlash from NETZSCH Japan K.K.). The thermal conductivity is 0.5 W/m·K or more for practical use, preferably 0.7 W/m·K or more, and more preferably 0.9 W/m·K or more.

### Comparative Examples 4 to 6

Polyphenylene sulfide resin compositions with 40% by volume of the particles were prepared in the same way as in Example 2, and their thermal conductivity was measured.

TABLE 2

| | | Thermal |
|---|---|---|
| | Type of | conductivity |
| | filler | (W/m · K) |
| Ex. 5 | Ex. 1 | 0.94 |
| Comp. Ex. 4 | Comp. Ex. 1 | 0.74 |
| Comp. Ex. 5 | Comp. Ex. 2 | 0.62 |
| Comp. Ex. 6 | Comp. Ex. 3 | 0.63 |

1. A gahnite particle comprising zinc atoms, aluminum atoms, and oxygen atoms, and molybdenum atoms, wherein
the gahnite particle has a dielectric loss tangent of 1.0×10⁻³ or less at 1 GHz.

2. The gahnite particle according to claim 1, wherein the gahnite particle has an average particle size of 0.1 to 15 μm.

3. A method for producing the gahnite particle according to claim 1, the method comprising firing a zinc compound and an aluminum compound in presence of a molybdenum compound.

4. The method for producing the gahnite particle according to claim 3, the method comprising steps of:
(1) preparing an intermediate by heating a first mixture (A-1) including a molybdenum compound and a zinc compound, or a first mixture (A-2) including a molybdenum compound, a zinc compound, and an aluminum compound; and
(2) producing a gahnite particle by firing a second mixture including the intermediate when the first mixture (A-2) is used, or a second mixture including the intermediate and an aluminum compound when the first mixture (A-1) is used, at a temperature higher than a heating temperature selected in step (1).

5. The method for producing the gahnite particle according to claim 3, the method comprising: a firing step of growing a zinc compound and an aluminum compound into a gahnite particle by solid solution formation and crystal formation in presence of a molybdenum compound; and a cooling step of further crystallizing the gahnite particle grown in the firing step.

6. The method for producing the gahnite particle according to claim 3, wherein a molar ratio of molybdenum atoms in the molybdenum compound to zinc atoms in the zinc compound (molybdenum atoms/zinc atoms) is 0.012 to 1.5.

7. The method for producing the gahnite particle according to claim 3, wherein firing temperature is 800 to 1300° C.

8. A resin composition comprising:
the gahnite particle according to claim 1; and
a resin.

9. A molded product of the resin composition according to claim 8.
